(19) United States
(12) Patent Application Publication
(10) Pub. No.: US 2009/0231312 A1
(43) Pub. Date: Sep. 17, 2009

(54) Device substrate and liquid crystal panel

(76) Inventor: Yohsuke Fujikawa, Tokyo (JP)

Correspondence Address: HARNESS, DICKEY & PIERCE, P.L.C., P.O. BOX 8910, RESTON, VA, 20195, US

(21) Appl. No.: 11/921,898

(22) PCT Filed: Apr. 21, 2006
(86) PCT No.: PCT/JP2006/308403

§ 371 Date: Dec. 10, 2007

(30) Foreign Application Priority Data
Aug. 30, 2005 (JP) 2005-248538

(51) Int. Cl. G09G 3/36; G09G 5/00

(52) U.S. Cl. 345/206; 349/149

(57) ABSTRACT

A frame size of a device substrate is reduced without a considerable change of a layout. An element side substrate 10 of a liquid crystal panel includes an element array having display elements 41, and a row control circuit 12 controlling the display elements 41 by a row, formed on a base substrate 11 monolithically. The row control circuit 12 has a configuration of arranging flip-flop circuits 13 corresponding to rows of the display elements 41 consecutively in a one-dimensional manner. An arrangement pitch P_G of the flop-flop circuits 13 is smaller than that P_G_PIX of the rows of the display elements 41, and also a difference between both of the pitches is set to be equal to or smaller than a minimum wiring width or a minimum wiring pitch allowable in the row control circuit 12. A video signal line group, a level shifter, or the like is placed in a vacant area which is obtained by a reduction of the row control circuit 12 in the longitudinal direction thereof. A column control circuit may be reduced in the longitudinal direction thereof with a similar method.

### TECHNICAL FIELD

The present invention relates to a device substrate and a liquid crystal panel, and particularly to a device substrate on which elements and a control circuit thereof are formed monolithically and a liquid crystal panel using the same.

### BACKGROUND ART

A variety of flat type display devices represented by a liquid crystal panel has been applied for a practical use and mounted on a mobile electronic device and other various kinds of electronic devices. Recently, in particular, a liquid crystal panel provided with an element side substrate on which display elements and a drive circuit thereof are formed monolithically (hereinbelow, referred to as a monolithic liquid crystal panel) has been practically used for downsizing the devices.

In reference to FIGS. 16 and 17, a configuration of a monolithic liquid crystal panel will be described. FIG. 16 is a diagram showing an appearance of a liquid crystal panel. As shown in FIG. 16, the liquid crystal panel has a structure of bonding an element side substrate 1 and an opposite substrate 2. On an area where the element side substrate 1 and the opposite substrate 2 overlap, there is formed a pixel region 3 having display elements arranged therein. An outer peripheral part of the pixel region 3 is covered by a black matrix 4. On the area covered by the black matrix 4 on the element side substrate 1, a drive circuit for display elements and the like are formed.

On one side of the liquid crystal panel, multiple external terminals 5 are provided. The external terminals 5 include a power supply terminal, a control terminal for the drive circuit formed on the element side substrate 1, a terminal for applying a preset voltage to an opposite electrode formed on the opposite substrate 2, and a terminal for applying a preset voltage to a storage capacitance line formed on the element side substrate 1, etc.

FIG. 17 is a plan view of an element side substrate in a conventional liquid crystal panel. An element side substrate 90 shown in FIG. 17 is a device substrate which includes display elements and a drive circuit thereof formed monolithically on a base substrate 91. On the base substrate 91, there are formed display elements 41, a row control circuit 92, a column control circuit 96, external terminals 42, a row-side level shifter 43, a column-side level shifter 44 and a common transfer member 45. Note that an opposite electrode 46 is formed on an opposite substrate (not shown in the drawing) facing the element side substrate 90.

The display elements are arranged on the base substrate 91 to have 3m elements in a row direction and n elements in a column direction for forming a pixel array. The row control circuit 92 includes n flip-flop circuits 93, n level shifters 94 and n output circuits 95, and controls the display elements 41 by a row. The column control circuit 96 includes k (k=m/2) flip-flop circuits 97, k level shifters 98 and 3m sampling circuits 99, and controls the display elements 41 by a column. Note that an operation of the circuit formed on the element side substrate 90 is the same as that of a circuit formed on an element side substrate 10 (FIG. 1) described hereinafter and the description thereof will be omitted here.

An outer peripheral part of the pixel array is called a “frame”. The row control circuit 92 and the column control circuit 96, and also wires connecting these control circuits and the external terminals 42 are placed in the frame (typically, on two sides of the frame neighboring each other) For example, the row control circuit 92 is placed on one side of the frame (side in the column direction) separated from the pixel array by about several hundreds of micrometers, and the column control circuit 96 is placed on the other side of the frame (side in the row direction) separated from the pixel array by about several hundreds of micrometers.

Generally, on the element side substrate 90, an arrangement pitch P_G of flip-flop circuits 93 is set to be the same as that P_G_PIX of rows of display elements 41, and an arrangement pitch P_S of sampling circuits 99 is set to be the same as that P_S_PIX of columns of the display elements 41 (refer to FIG. 17).

Also, conventionally, there is known an element side substrate on which the same number of flip-flop circuits as that of sampling circuits is included in a column control circuit. On this element side substrate, an arrangement pitch of the flip-flop circuits included in the column control circuit is set to be the same as that of columns of display elements.

Note that technologies relating to the present invention are disclosed in the following references. Patent reference 1 discloses that a drive circuit, a longitudinal size of which is smaller than a width or a height of a pixel region, is placed on a pixel matrix substrate. Patent reference 2 discloses that an arrangement pitch of active elements included in a scanning driver and a data driver is reduced and a common transfer electrode is placed on a wiring area generated thereby via an insulating film. FIG. 24 in Patent reference 3 discloses that a line-block selection circuit and pixels are connected with fan-like diagonal wires.

[Patent reference 1] Japanese Patent Application Laid-Open Publication No. 2000-292805

[Patent reference 2] Japanese Patent Application Laid-Open Publication No. 2002-6331

[Patent reference 3] Japanese Patent Application Laid-Open Publication No. 2003-186045

### DISCLOSURE OF THE INVENTION

### Problems to be Solved by the Invention

While, in recent monolithic liquid crystal panels, a width of a frame side, on a part which a row control circuit is placed, is about 2 to 3 mm and a width of a frame side, on a part of which a column control circuit is placed, is about 4 mm, a frame size is required to be as small as possible for downsizing a device. Also, reduction of a frame size in an element side substrate increases the number of element side substrates mountable on a mother substrate, resulting in reduction of a panel cost. Therefore, reducing a frame size even slightly is important from a practical point of view.

In a case a row control circuit is placed on one side of a frame and a column control circuit is placed on the other side of the frame, a frame width should be about the same as a lateral length of the row control circuit or the column control circuit. In an actual monolithic liquid crystal panel, however, frame widths are frequently larger than lateral lengths of control circuits.

For example, in a case a row control circuit is placed on one side of a frame and a column control circuit is placed on the other side of the frame, other circuits are to be placed at four corners of the frame. In the four corners of the frame, however, it is necessary also to place wires connecting circuits formed on the element side substrate and external terminals. Particularly at two corners near the external terminals of the four corners of the frame (R1 and R2 shown in FIG. 16), it is necessary to place a number of wires connected to the external terminals. Circuits and wires are placed as localized at apart of the element side substrate in this manner, sometimes resulting in increase of a frame size.

Also, there is a case a signal source circuit provided outside a liquid crystal panel is operated at a lower voltage than a circuit formed on an element side substrate. In this case, a level shifter (for example, a row-side level shifter 43 or a column-side level shifter 44 shown in FIG. 17) is provided on the element side substrate for converting a level of a signal transmitted between the circuit formed on the element side substrate and an external terminal. However, when a size of the level shifter is larger than the lateral length of a row control circuit or a column control circuit, a frame size is increased.

Also, in a case a video signal supplied to a liquid crystal panel is phase-expanded, a frame size is sometimes increased. For example, in a case a video signal is four-phase-expanded, it is necessary to place 12 (RGB×4) video signal lines in total on an element side substrate. When a width of the video signal lines is 50 μm and a wiring pitch is 10 μm, a width of a video signal line wiring area becomes 710 μm. A phase expansion of a video signal, though efficient in a large screen liquid crystal panel, becomes also a factor of increasing a frame size.

Also, a liquid crystal panel provided with a display element accommodating four or more colors for improving a display quality is proposed. In this liquid crystal panel, a frame size may be increased as the number of video signal lines placed on an element side substrate increases.

Also, there is proposed a liquid crystal panel having an element side substrate on which a circuit unrelated to display (for example, an audio-amplifier or the like) is formed monolithically. In this liquid crystal panel, a frame size may be increased, since the circuit unrelated to display and wires for supplying signals to the circuit are to be placed on an element side substrate.

Meanwhile, methods for reducing a frame size are devised as follows. First, there is devised a method of reducing a lateral size of a row control circuit or a column control circuit. In a recent monolithic liquid crystal panel, however, a lateral size of a row control circuit is about 1 to 2 mm and a lateral size of a column control circuit is about 3 mm, and there is almost no room further to reduce these sizes.

Also, there is devised a method of forming a vacant area for placing a circuit or a wire by moving a row control circuit or column control circuit to a corner of an element side substrate. However, a frame size may be increased sometimes adversely in another part thereof from such a reason that an area for a common transfer member has to be kept.

Also, there is devised a method of preventing wires from localizing by dividing video signal lines to be placed on an element side substrate into two or more groups and by placing the video signal lines in different paths by a group. When video signal lines are placed in different paths, however, a wiring load and a delay time become irregular among video signal lines and a display quality may be deteriorated.

Accordingly, an object of the present invention is to realize a device substrate having a reduced frame size without changing a layout considerably and a liquid crystal panel using the same.

### MEANS FOR SOLVING THE PROBLEMS

A first aspect of the present invention is a device substrate having elements and a control circuit thereof formed monolithically; including:

a base substrate;

an element array including elements arranged in a matrix on the base substrate; and

a control circuit being placed along a side of the element array on the base substrate for controlling the elements by a row or by a column,

the control circuit having a configuration of arranging unit control circuits corresponding to control units of the elements consecutively in a one-dimensional manner, and

an arrangement pitch of the unit control circuits being smaller than that of the control units of the elements, and a difference between both of the pitches being equal to or smaller than a minimum wiring width or a minimum wiring pitch allowable in the control circuit.

A second aspect of the present invention is the device substrate according to the first aspect, wherein;

the control circuit has a configuration of arranging flip-flop circuits corresponding to rows of the elements consecutively in a one-dimensional manner along a side of the element array in a column direction thereof; and

an arrangement pitch of the flip-flop circuits is smaller than that of the rows of the elements, and a difference between both of the pitches is equal to or smaller than the minimum wiring width or the minimum wiring pitch.

A third aspect of the present invention is the device substrate according to the first aspect, wherein;

the control circuit has a configuration of arranging flip-flop circuits corresponding to columns of the elements consecutively in a one-dimensional manner along a side of the element array in a row direction thereof; and

an arrangement pitch of the flip-flop circuits is smaller than that of the columns of the elements, and a difference between both of the pitches is equal to or smaller than the minimum wiring width or the minimum wiring pitch.

A fourth aspect of the present invention is the device substrate according to the first aspect, wherein;

the control circuit has a configuration of arranging sampling circuits corresponding to the columns of the elements consecutively in a one-dimensional manner along a side of the element array in a row direction thereof; and

an arrangement pitch of the sampling circuits is smaller than that of the columns of the elements, and a difference between both of the pitches is equal to or smaller than the minimum wiring width or the minimum wiring pitch.

A fifth aspect of the present invention is the device substrate according to the first aspect, wherein;

the control circuit is placed so as to form a vacant area near a corner of an outer peripheral part of the element array; and

a wiring group for transmitting multiple signals of the same kind simultaneously is placed in the vacant area.

A sixth aspect of the present invention is the device substrate according to the fifth aspect, wherein;

the wiring group includes multiple video signal lines.

A seventh aspect of the present invention is the device substrate according to the fifth aspect, wherein;

the wiring group includes multiple phase-expanded video signal lines.

A eighth aspect of the present invention is the device substrate according to the fifth aspect, wherein;

the wiring group includes four or more video signal lines corresponding to respective color signals.

A ninth aspect of the present invention is the device substrate according to the first aspect, wherein;

the control circuit is placed so as to form a vacant area near a corner of an outer peripheral part of the element array; and

a level shifter converting a level of a signal transmitted between an external terminal and the control circuit is placed in the vacant area.

A tenth aspect of the present invention is the device substrate according to the first aspect, further including;

a precharge circuit for precharging a column wire corresponding to a column of the elements placed along a side of the element array on the base substrate in a row direction thereof,

the control circuit being placed so as to form a vacant area near a corner of an outer peripheral part of the element array, and

a wire connecting an external terminal and the precharge circuit passing through the vacant area.

An eleventh aspect of the present invention is the device substrate according to the first aspect, further including;

another control circuit being placed along another side of the element array on the base substrate, for controlling the elements either by a row or by a column differently from the control unit.

A twelfth aspect of the present invention is a device substrate according to the eleventh aspect, wherein;

the control circuit is placed so as to form a vacant area near a corner of an outer peripheral part of the element array; and

a level shifter converting a level of a signal transmitted between an external terminal and the another control circuit is placed in the vacant area.

A thirteenth aspect of the present invention is the device substrate according to the first aspect, further including;

another control circuit being divided into a first part and a second part to be placed along other two sides of the element array on the base substrate, for controlling the elements either by a row or by a column differently from the control circuit,

the control circuit being placed so as to form vacant areas near two corners of an outer peripheral part of the element array, respectively, and

a wire connecting an external terminal and the first part passing through one of the vacant areas and a wire connecting an external terminal and the second part passing through the other of the vacant areas.

A fourteenth aspect of the present invention is a liquid crystal panel which has a structure of bonding two substrates, including:

an element side substrate including a base substrate, a pixel array having display elements arranged in a matrix on the base substrate, and a control circuit being placed along a side of the pixel array on the base substrate for controlling the display elements by a row or by a column; and

an opposite substrate facing the element side substrate;

the control circuit having a configuration of arranging unit control circuits corresponding to control units of the display elements consecutively in a one-dimensional manner, and

an arrangement pitch of the unit control circuits being smaller than that of the control units of the display elements and a difference between both of the pitches being equal to or smaller than a minimum wiring width or a minimum wiring pitch allowable in the control circuit.

### ADVANTAGES OF THE INVENTION

According to the first aspect of the present invention, by use of a control circuit, a longitudinal size of which is smaller than a size of an element array in the same direction, a vacant area (area where an element or a control circuit thereof is not placed) is formed in a frame, on a part of which the control circuit is placed. Therefore, a frame size of a device substrate can be reduced by placing a circuit or a wire in the formed vacant area. Also, by reducing a frame size, the number of device substrates mountable on a mother substrate can be increased to reduce a cost of the device substrate. Also, since a difference between an arrangement pitch of control units of elements and that of unit control circuits is small, a longitudinal size of the control circuit can be reduced almost without increasing a lateral size of the control circuit.

According to the second aspect of the present invention, in a case a control circuit is a row control circuit having a configuration of arranging flip-flop circuits consecutively, a size of the row control circuit in a column direction becomes smaller than that of a pixel array in the column direction, by arranging the flip-flop circuits with a pitch slightly smaller than that of rows of elements. A circuit or a wire can be placed in a vacant area thereby formed to reduce a frame size of a device substrate.

According to the third aspect of the present invention, in a case a control circuit is a column control circuit having a configuration of arranging flip-flop circuits consecutively, a size of the column control circuit in a row direction becomes smaller than that of a pixel array in the row direction, by arranging the flip-flop circuits with a pitch slightly smaller than that of columns of elements. A circuit or a wire can be placed in a vacant area thereby formed to reduce a frame size of a device substrate.

According to the fourth aspect of the present invention, in a case a control circuit is a column control circuit having a configuration of arranging sampling circuits consecutively, a size of the column control circuit in a row direction becomes smaller than that of a pixel array in the row direction, by arranging the sampling circuits with a pitch slightly smaller than that of columns of elements. A circuit or a wire can be placed in a vacant area thereby formed to reduce a frame size of a device substrate.

According to the fifth aspect of the present invention, when a wire group for transmitting multiple signals of the same kind simultaneously is placed in a vacant area formed by placing a control circuit appropriately, a frame size of a device substrate can be reduced while the wire group is placed in the same path to keep equality of lengths thereof.

According to the sixth aspect of the present invention, a frame size of a device substrate can be reduced, while multiple video signal lines are placed in the same path to keep equality of lengths thereof.

According to the seventh aspect of the present invention, a frame size of a device substrate can be reduced, while multiple phase-expanded video signal lines are placed in the same path to keep equality of lengths thereof.

According to the eighth aspect of the present invention, a frame size of a device substrate can be reduced, while four or more video signal lines corresponding to respective color signals are placed in the same path to keep equality of lengths thereof.

According to the ninth aspect of the present invention, a level shifter for a control circuit is placed in a vacant area formed by placing the control circuit appropriately, and thereby a size of a device substrate can be reduced.

According to the tenth aspect of the present invention, a wire connecting an external terminal and a precharge circuit is placed in a vacant area formed by placing a control circuit appropriately, and thereby a size of a device substrate can be reduced.

According to the eleventh aspect of the present invention, also in a device substrate provided with another control circuit, a vacant area is formed in a frame, on a part of which a former control circuit is placed, and thereby a frame size can be reduced by placing a circuit or a wire in the formed vacant area.

According to the twelfth aspect of the present invention, a level shifter for another control circuit is placed in a vacant area formed by placing a former control circuit appropriately, and thereby a frame size of a device substrate can be reduced.

According to the thirteenth aspect of the present invention, control wires for another control circuit divided into two are placed in two vacant areas formed by placing a former control circuit appropriately, and thereby a size of a device substrate can be reduced.

According to the fourteenth aspect of the present invention, by use of a control circuit, a longitudinal size of which is smaller than a pixel array size in the same direction, a vacant area (area where an element or a control circuit thereof is not placed) is formed in a frame, on a part of which the control circuit is placed. Therefore, a circuit or a wire is placed in the formed vacant area, and thereby a frame size of an element side substrate can be reduced resulting in reduction of an overall size of a liquid crystal panel. Also, by reducing a frame size of an element side substrate, the number of element side substrates mountable on another substrate can be increased, resulting in reduction of a cost of a liquid crystal panel.

### BRIEF DESCRIPTION OF THE DRAWINGS

FIG. 1 is a plan view of an element side substrate of a liquid crystal panel according to a first embodiment of the present invention.

FIG. 2 is a plan view of an element side substrate of a liquid crystal panel according to a second embodiment of the present invention.

FIG. 3 is a plan view of an element side substrate of a liquid crystal panel according to a third embodiment of the present invention.

FIG. 4A is a diagram showing a wiring pitch in an element side substrate of a conventional liquid crystal panel.

FIG. 4B is a diagram showing a wiring pitch in an element side substrate of a conventional liquid crystal panel.

FIG. 4C is a diagram showing a wiring pitch in an element side substrate of a liquid crystal panel according to an embodiment of the present invention.

FIG. 4D is a diagram showing a wiring pitch in an element side substrate of a liquid crystal panel according to an embodiment of the present invention.

FIG. 5 is an enlarged view of a part X shown in FIG. 4C.

FIG. 6 is a plan view of a first example of a device substrate according to an embodiment of the present invention.

FIG. 7 is a plan view of a second example of a device substrate according to an embodiment of the present invention.

FIG. 8 is a plan view of a third example of a device substrate according to an embodiment of the present invention.

FIG. 9 is a plan view of a fourth example of a device substrate according to an embodiment of the present invention.

FIG. 10 is a plan view of a fifth example of a device substrate according to an embodiment of the present invention.

FIG. 11 is a plan view of a sixth example of a device substrate according to an embodiment of the present invention.

FIG. 12 is a plan view of a seventh example of a device substrate according to an embodiment of the present invention.

FIG. 13 is a plan view of an eighth example of a device substrate according to an embodiment of the present invention.

FIG. 14 is a plan view of a ninth example of a device substrate according to an embodiment of the present invention.

FIG. 15 is a plan view of a tenth example of a device substrate according to an embodiment of the present invention.

FIG. 16 is a diagram showing an appearance of a monolithic liquid crystal panel.

FIG. 17 is a plan view of an element side substrate of a conventional liquid crystal panel.

### DESCRIPTION OF THE REFERENCE SYMBOLS

10, 20, and 30 Element side substrate

11, 21, and 31 Base substrate

12, 22, and 32 Row control circuit

13, 23, and 33 Flip-flop circuit

14, 24, and 34 Level shifter

15, 25, and 35 Output circuit

16, 26, and 36 Column control circuit

17, 27, and 37 Flip-flop circuit

18, 28, and 38 Level shifter

19, 29, and 39 Sampling circuit

41 Display element

42 External terminal

43 Row-side level shifter

44 Column-side level shifter

45 Common transfer member

46 Opposite electrode

47 Scanning signal line

48 Data signal line

### BEST MODES FOR CARRYING OUT THE INVENTION

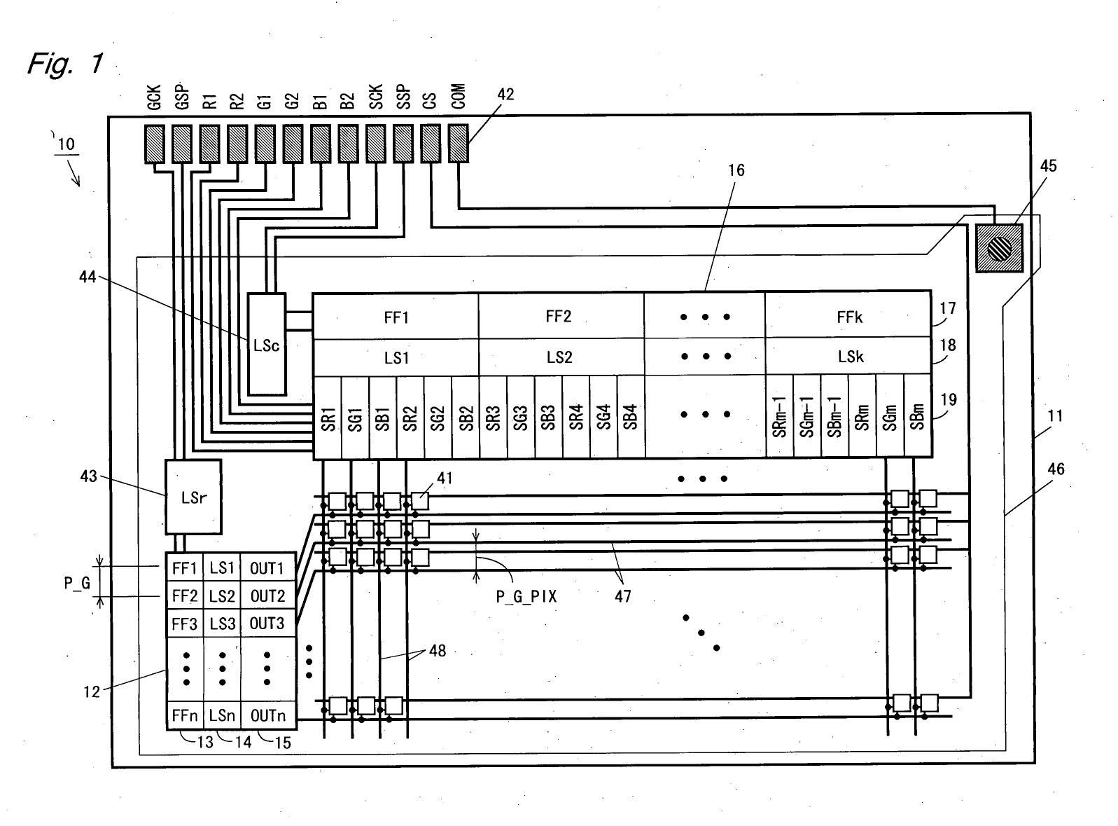

FIGS. 1 to 3 are plan views of element side substrates of liquid crystal panels according to the first to third embodiments, respectively, of the present invention. Each of the element side substrates 10, 20, and 30 shown in FIGS. 1 to 3 is a device substrate which includes display elements and a drive circuit thereof formed monolithically on a base substrate 11, 21, or 31. By bonding the element side substrate 10, 20, or 30 and an opposite substrate as shown in FIG. 16, a liquid crystal panel according to each of the first to third embodiments of the present invention can be obtained.

In the element side substrate 10 shown in FIG. 1, display elements 41, a row control circuit 12, a column control circuit 16, external terminals 42, a row-side level shifter 43, a column-side level shifter 44 and a common transfer member 45 are formed on a base substrate 11. The display elements 41 are arranged on the base substrate 11 to have 3m elements in a row direction and n elements in a column direction for forming a pixel array. The row control circuit 12 includes n flip-flop circuits 13, n level shifters 14, and n output circuits 15. The column control circuit 16 includes k (k=m/2) flip-flop circuits 17, k level shifters 18, and 3m sampling circuits 19.

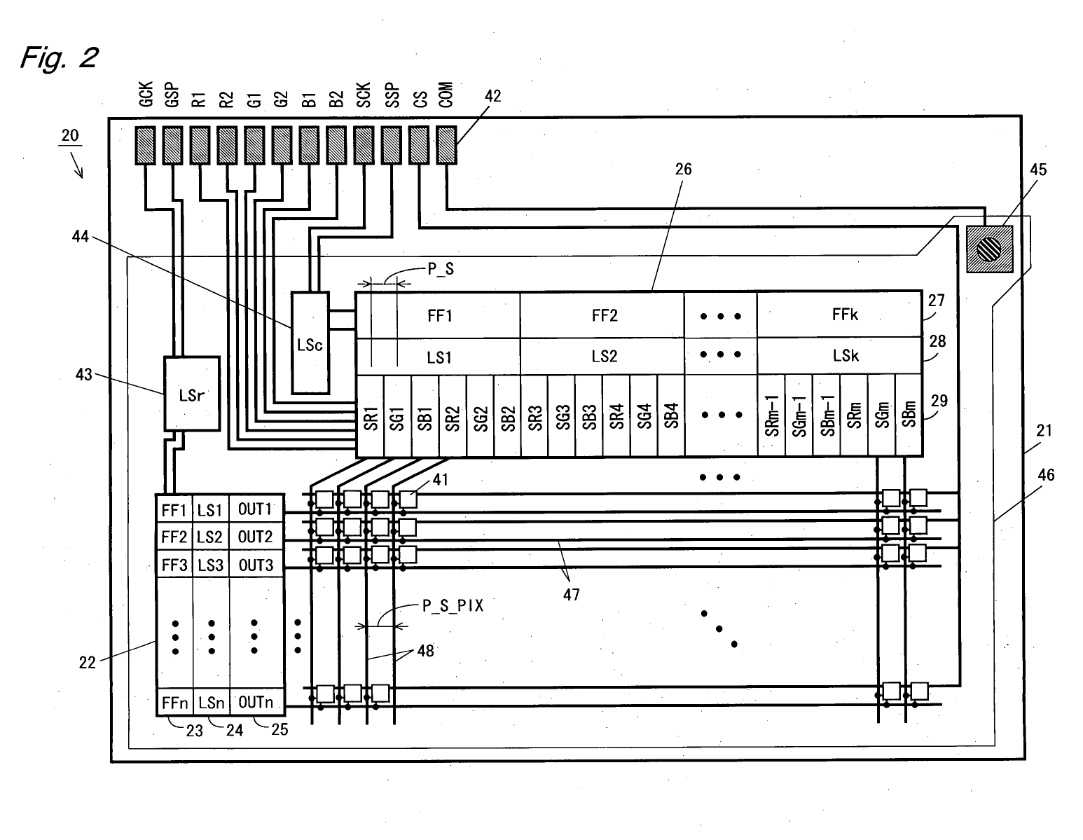

The element side substrate 20 shown in FIG. 2 is the same as the element side substrate 10 except for a layout configuration thereof. In the element side substrate 20, display elements 41, a row control circuit 22, a column control circuit 26, external terminals 42, a row-side level shifter 43, a column-side level shifter 44, and a common transfer member 45 are formed on a base substrate 21. The display elements 41 are arranged on the base substrate 21 to have 3m elements in a row direction and n elements in a column direction for forming a pixel array. The row control circuit 22 includes n flip-flop circuits 23, n level shifters 24, and n output circuits 25. The column control circuit 26 includes k (k=m/2) flip-flop circuits 27, k level shifters 28, and 3m sampling circuits 29.

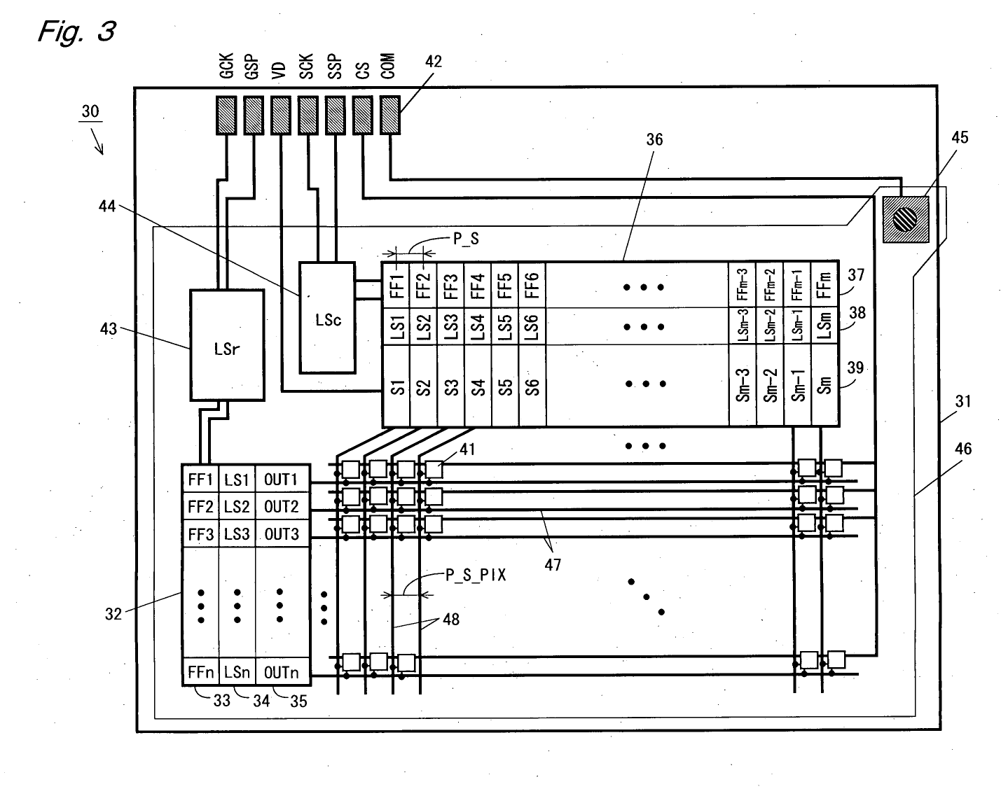

The element side substrate 30 shown in FIG. 3 has a layout configuration similar to that of the element side substrate 20. In the element side substrate 30, display elements 41, a row control circuit 32, a column control circuit 36, external terminals 42, a row-side level shifter 43, a column-side level shifter 44, and a common transfer member 45 are formed on a base substrate 31. The display elements 41 are arranged on the base substrate 31 to have m elements in a row direction and n elements in a column direction for forming a pixel array. The row control circuit 32 includes n flip-flop circuits 33, n level shifters 34, and n output circuits 35. The column control circuit 36 includes m flip-flop circuits 37, m level shifters 38, and m sampling circuits 39.

Here, the row control circuits 12, 22, and 32 are also called gate drivers and the column control circuits 16, 26, and 36 are also called source drivers. Also, in FIGS. 1 to 3, only wires required for descriptions hereinbelow are shown in the drawings and other wires (power supply wire, for example) are omitted. Also, opposite electrodes 46 shown in FIGS. 1 to 3 are formed on opposite substrates (not shown in the drawings) facing the base substrates 11, 21, and 31, respectively. Hereinbelow, a row direction of display elements 41 (horizontal direction in the drawings) is simply referred to as a “row direction”, and a column direction of display elements 41 (vertical direction in the drawings) is simply referred to as a “column direction”.

Hereinbelow, with reference to FIG. 1, a configuration (note that a layout configuration will be described hereinafter) and an operation of the element side substrate 10 will be described. The display elements 41 are arranged to have 3m elements in the row direction and n elements in the column direction for forming a pixel array, as described above. In this pixel array, there are arranged n scanning signal lines 47 (also called gate bus lines) and 3m data signal lines 48 (also called source bus lines). Each scanning signal line 47 is connected to display elements 41 arranged in the same row. Each data signal line 48 is connected to display elements 41 arranged in the same column. Three display elements 41 arranged consecutively in the row direction correspond sequentially to sub-pixels (also called picture elements) of red, green, and blue.

The row control circuit 12 controls the display elements 41 by a row using the n scanning signal lines 47. A row of the display elements 41 is controlled using a flip-flop circuit 13, a level shifter 14 and an output circuit 15.

n flip-flop circuits 13 are connected serially to form a shift register with n stages. To a data input terminal of the shift register, a gate start pulse GSP is supplied via an external terminal 42. To a clock terminal of the shift register, a gate clock GCK is supplied via an external terminal 42. The gate start pulse GSP exhibits an active state (here, high level) at a rate of once in a frame time. The gate clock GCK exhibits a change into a preset direction (here, rising direction) at a rate of once in a line time.

Output signals from the n flip-flop circuits 13 usually exhibit a low level. When the gate clock GCK exhibits a rise during the gate start pulse GSP is in the active state, only an output signal of the first flip-flop circuit 13 becomes to exhibit a high level. When the gate clock GCK exhibit a rise next, only an output signal of the second flip-flop circuit 13 becomes to exhibit a high level. It follows in the same manner that, each time the gate clock GCK exhibits a rise, only an output signal of the third, the fourth, . . . flip-flop circuit 13 sequentially becomes to exhibit a high level.

The level shifter 14 converts a voltage of the output signal of the flip-flop circuit 13 into a level which can be input into the output circuit 15. Here, the level shifter 14 is provided in a case the output signal of the flip-flop circuit 13 can not directly control the output circuit 15.

The output circuit 15 switches a voltage applied to the scanning signal line 47 between a first level (level corresponding to an active state) and a second level (level corresponding to an inactive state) according to the output signal of the level shifter 14.

Accordingly, in the first line time, a voltage applied to the first scanning signal line 47 becomes the first level and display elements 41 in the first row are controlled into a selected state. In the second line time, a voltage applied to the second scanning signal line 47 becomes the first level and display elements 41 in the second row are controlled into a selected state. It follows in the same manner that, in the i-th line time (i is an integer not smaller than one and not larger than n), a voltage applied to the i-th scanning signal line 47 becomes the first level and display elements 41 in the i-th line are controlled into a selected state. In this manner, display elements 41 are controlled into a selected state by a row in each line time.

Generally, when video signals, the number of which is “the number of signal lines corresponding to respective color signals”×“a”, are supplied to a liquid crystal panel, “a” is called a phase expansion number. To the element side substrate 10, six analog video signals R1, R2, G1, G2, B1, and B2 are supplied and the phase expansion number is two.

The column control circuit 16 controls the display elements 41 by a column using the 3m data signal lines 48. The display elements 41 are divided into groups by six columns and each group is controlled using a flip-flop circuit 17, a level shifter 18, and six sampling circuits 19. Here, when a phase expansion number is denoted by “a”, the display elements 41 are divided into groups by 3a columns, and each group is controlled using a flip-flop circuit 17, a level shifter 18, and 3a sampling circuits 19.

k (k=m/2) flip-flop circuits 17 are serially connected to form a shift register with k stages. Here, generally, when a phase expansion number is denoted by “a”, m/a flip-flop circuits 13 form a shift register with m/a stages. To a data input terminal of the shift register, a source start pulse SSP is supplied via an external terminal 42. To a clock terminal of the shift register, a source clock SCK is supplied via an external terminal 42. The source start pulse SSP becomes to exhibit an active state (here, high level) at a rate of once in a line time. The source clock SCK exhibits a change to a preset direction (here, a rising direction) at a timing to sample the video signal.

Output signals of the k flip-flop circuits 17 usually exhibit a low level. When the source clock SCK exhibits a rise while the source start pulse SSP exhibits an active state, only an output signal of the first flip-flop circuit 17 becomes to exhibit a high level. When the source clock SCK exhibits a rise next, only an output signal of the second flip-flop circuit 17 becomes to exhibit a high level. It follows in the same manner that, each time the source clock rises, only an output signal of the third, the fourth, . . . flip-flop circuit 17 sequentially becomes to exhibit a high level.

The level shifter 18 converts the voltage of an output signal of the flip-flop circuit 17 into a level which can be input into the sampling circuit 19. Here, the level shifter 18 is provided in a case the output signal of the flip-flop circuit 17 can not directly control the sampling circuit 19.

The sampling circuit 19 samples any of six video signals R1, R2, G1, G2, B1, and B2, when the output signal of the level shifter 18 becomes to exhibit a high level. The sampled signal is supplied to the data signal line 48. In the element side substrate 10, one flip-flop circuit 17 corresponds to six sampling circuits 19. Thereby, when an output signal of a flip-flop circuit 17 becomes to exhibit a high level, six sampling circuits 19 carry out sampling simultaneously and six video signals are supplied to six data signal lines 48 simultaneously.

The row-side level shifter 43 converts voltages of the signals GCK and GSP input via external terminals 42 into levels which can be input into the row control circuit 12. The column-side level shifter 44 converts voltages of the signals SCK and SSP input via external terminals 42 into levels which can be input into the column control circuit 16. Here, the row-side level shifter 43 is provided when the signals input via the external terminals 42 can not directly control the row control circuit 12, and the column-side level shifter 44 is provided when the signals input via the external terminals 42 can not directly control the column control circuit 16.

In this manner, the row control circuit 12 selects a row of the display elements 41 sequentially and the column control circuit 16 supplies video signals to the row of the display elements 41. The display element .41 switches display state thereof according to the video signal supplied by the column control circuit 16 when selected by the row control circuit 12. A screen display is performed when the display elements 41 are selected by a row and video signals are supplied to the selected row of the display elements.

A configuration (here, except for a layout configuration) and an operation of the element side substrate 20 shown in FIG. 2 are the same as those of the element side substrate 10 and the description thereof is omitted here. A configuration (here, except for a layout configuration) and an operation of the element side substrate 30 shown in FIG. 3 are different from those of the element side substrate 10. In the element side substrate 30, the column control circuit 36 controls the display elements 41 by a column using m data signal lines 48. An analog video signal VD is supplied to the column control circuit 36 via an external terminal 42. A row of the display elements 41 is controlled using a flip-flop circuit 37, a level shifter 38, and a sampling circuit 39.

m flip-flop circuits 37 are connected serially to form a shift register with m stages. To a data input terminal and a clock terminal of the shift register, the same signals SCK and SSP as in the element side substrate 10 are supplied via external terminals 42. The level shifter 38 converts a voltage of an output signal of the flip-flop circuit 37 into a level which can be input into the sampling circuit 39. The sampling circuit 39 samples the video signal VD when the output signal of the level shifter 38 becomes to exhibit a high level. The sampled signal is supplied to the data signal line 48.

Hereinbelow, layout configurations will be described for the element side substrates 10, 20, and 30. In the element side substrate 10 shown in FIG. 1, the flip-flop circuit 13 is designed such that a size thereof in the column direction (size in the column direction when arranged on the element side substrate) is smaller than that of the display element 41 in the column direction. The level shifter 14 and the output circuit 15 are designed such that sizes thereof in the column direction are equal to or smaller than a size of the flip-flop circuit 13 in the column direction.

n flip-flop circuits 13 are arranged consecutively in a one-dimensional manner along a side of the pixel array in the column direction. A level shifter 14 and an output circuit 15 are arranged together with a corresponding flip-flop circuit 13 in the row direction. Accordingly, the level shifters 14 and the output circuits 15 are arranged in the same pitch as the flip-flop circuits 13, respectively.

Also, while an arrangement pitch P_G of the flip-flop circuits 13 is set to be smaller than that P_G_PIX of the rows of the display elements 41, a difference between these two arrangement pitches is provided with a certain restriction. That is, the difference between the two arrangement pitches (P_G PIX−P_G) is limited to equal to or smaller than a minimum wiring width or a minimum wiring pitch allowed in designing the row control circuit 12. As a result, while a size of the row control circuit 12 in the column direction becomes smaller than that of the pixel array in the column direction, a difference between both of the sizes is equal to or smaller than n times the minimum wiring width or the minimum wiring pitch.

By use of a row control circuit 12 which is smaller than a pixel array in a size in the column direction in this manner, a vacant area (area where a display element or a control circuit thereof is not placed) can be formed in a frame, on a part of which the row control circuit 12 is placed. In the element side substrate 10 shown in FIG. 1, the row control circuit 12 is placed on a side of the frame (side in the column direction) at a position distant from the external terminals 42 (lower side in FIG. 1), and a vacant area is formed at an upper left corner of the frame. In the formed vacant area, the row-side level shifter 43, the column-side level shifter 44, phase-expanded video signal lines, and the like are placed. Thereby, a width of the frame, on a part of which the row control circuit 12 is placed, can be reduced.

Next, in the element side substrate 20 shown in FIG. 2, the sampling circuit 29 is designed such that a size thereof in the row direction (size in the row direction when arranged on the element side substrate) is smaller than that of the display element 41 in the row direction. The flip-flop circuit 27 and the level shifter 28 are designed such that sizes thereof in the row direction are equal to or smaller than six times the size of the sampling circuit 29 in the row direction (generally, equal to or smaller than 3a times, when a phase expansion number is denoted by “a”).

3m sampling circuits 29 are arranged consecutively in a one-dimensional manner along a side of the pixel array in the row direction. A flip-flop circuit 27 and a level shifter 28 are arranged together with corresponding six sampling circuits 29 in the column direction. Accordingly, the flip-flop circuits 27 and the level shifters 28 are arranged in the same pitch as the six sampling circuits 29.

Also, while an arrangement pitch P_S of the sampling circuits 29 is set to be smaller than that P_S_PIX of the columns of the display elements 41, a difference between these two arrangement pitches is provided with a certain restriction. That is, the difference between the two arrangement pitch (P_S_PIX−P_S) is limited to equal to or smaller than a minimum wiring width or a minimum wiring pitch allowed in designing the column control circuit 26. As a result, while a size of the column control circuit 26 in the row direction becomes smaller than that of the pixel array in the row direction, a difference between both of the sizes is equal to or smaller than 3m times the minimum wiring width or the minimum wiring pitch.

By use of a column control circuit 26 which is smaller than a pixel array in a size in the row direction in this manner, a vacant area can be formed in a frame, on a part of which the column control circuit 26 is placed. In the element side substrate 20 shown in FIG. 2, the column control circuit 26 is placed on a side of the frame (side in the row direction) at a position distant from the external terminals 42 (right side in FIG. 2), and a vacant area is formed at an upper left corner of the frame. In the formed vacant area, the row-side level shifter 43, the column-side level shifter 44, phase-expanded video signal lines, and the like are placed. Thereby, a width of the frame, on a part of which the column control circuit 26 is placed, can be reduced.

Next, in the element side substrate 30 shown in FIG. 3, the flip-flop circuit 37 is designed such that a size thereof in the row direction is smaller than that of the display element 41 in the row direction. The level shifter 38 and the sampling circuit 39 are designed such that sizes thereof in the row direction are equal to or smaller than the size of the flip-flop circuit 37 in the row direction.

m flip-flop circuits 37 are arranged consecutively in a one-dimensional manner along a side of the pixel array in the row direction. A level shifter 38 and a sampling circuit 39 are arranged together with a corresponding flip-flop circuit 37 in the column direction. Accordingly, the level shifters 38 and the sampling circuits 39 are arranged in the same pitch as the flip-flop circuits 37, respectively.

Also, while an arrangement pitch P_S of the flip-flop circuits 37 is set to be smaller than that P_S_PIX of the columns of the display elements 41, a difference between these two arrangement pitches is provided with a certain restriction. That is, the difference between the two arrangement pitch (P_S PIX−P_S) is limited to equal to or smaller than a minimum wiring width or a minimum wiring pitch allowed in designing the column control circuit 36. As a result, while a size of the column control circuit 36 in the row direction becomes smaller than that of the pixel array in the row direction, a difference between both of the sizes is equal to or smaller than m times the minimum wiring width or the minimum wiring pitch.

By use of a column control circuit 36 which is smaller than a pixel array in a size in the row direction in this manner, a vacant area can be formed in a frame, on a part of which the column control circuit 36 is placed. In the element side substrate 30 shown in FIG. 3, the column control circuit 36 is placed on a side of the frame (side in the row direction) at a position distant from the external terminals 42 (right side in FIG. 3), and a vacant area is formed at an upper left corner of the frame. In the formed vacant area, the row-side level shifter 43, the column-side level shifter 44, and the like are placed. Thereby, a width of the frame, on a part of which the column control circuit 36 is placed, can be reduced.

In this manner, as in the element side substrate 10, 20, or 30, a vacant area is formed by reducing a longitudinal size of the row control circuit 12 or the column control circuit 26 or 36, and circuits (for example, the row-side level shifter 43 and the column-side level shifter 44) and wires (for example, the phase-expanded video signal lines) are placed in the formed vacant area, and thereby, a width of a frame, on a part of which the row control circuit 12 or the column control circuit 26 or 36 is placed, can be reduced. Note that, a width of a frame can be reduced across two sides thereof, if permitted by a size of a circuit formed on an element side substrate and congestion degree of wires formed on the element side substrate.

Also, as in the element side substrate 10, 20, or 30, multiple video signal lines which connect the external terminals 42 and the column control circuit 16, 26 or 36 can be arranged without losing equality of lengths thereof (details are described hereinafter). Thereby, wiring loads of the video signal lines are uniformized and an image quality can be prevented from deteriorating. Also, when the row-side level shifter 43 and the column-side level shifter 44 are placed in the vacant area, a low-voltage signal source circuit can be thereby used outside a liquid crystal panel. Accordingly, a liquid crystal display device with lower power consumption can be configured by using an existing component widely commercialized.

Note that, while one of the row control circuit and the column control circuit is reduced in size in the element side substrate 10, 20 or 30, both of the row control circuit and the column control circuit may be reduced in size in the above described manner.

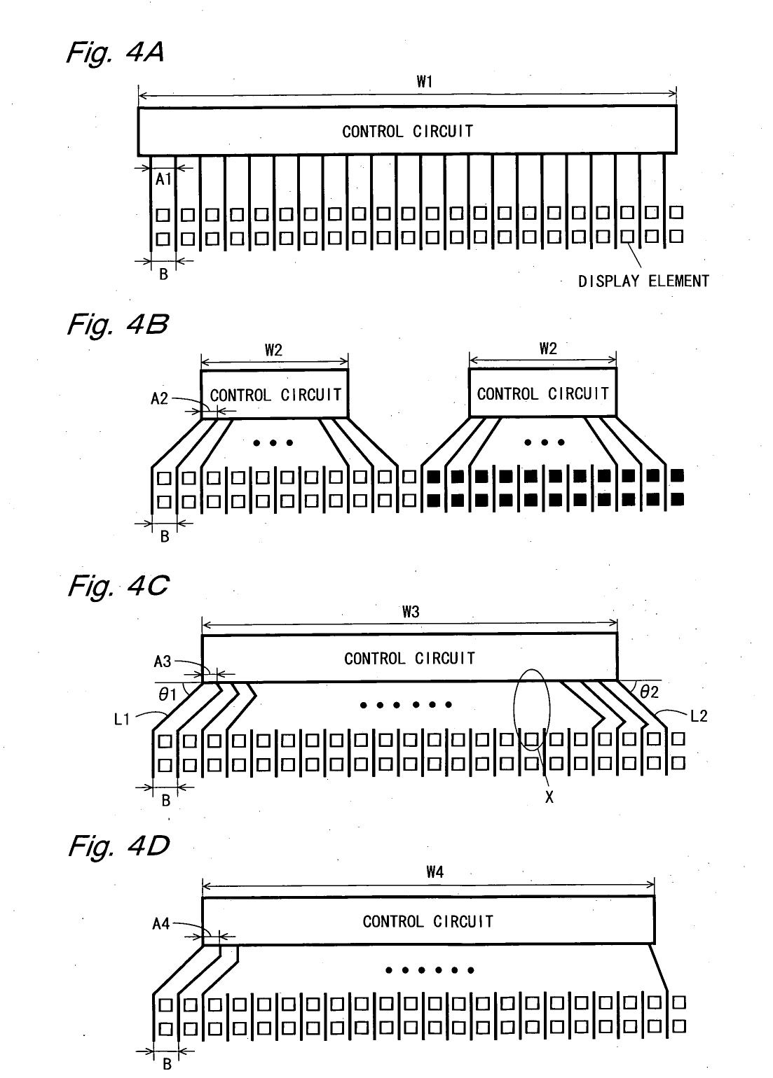

Hereinbelow, with reference to FIGS. 4A to 4D, layout configurations of the element side substrates 10, 20 and 30 will be described in comparison with a layout configuration of a conventional element side substrate. In FIGS. 4A to 4D and descriptions thereof, a row control circuit or a column control circuit formed monolithically on a element side substrate is called a “control circuit” and wiring controlled by the control circuit is called a “pixel interconnection”. In other words, this control circuit means either a row control circuit 12 or a column control circuit 26 or 36, and this pixel interconnection means either a scanning signal line 47 or a data signal line 48.

FIG. 4A is a diagram showing a wiring pitch in an element side substrate of a typical liquid crystal panel. On the typical element side substrate, an output position pitch A1 of a control circuit is set to be the same as an arrangement pitch B of display elements in the same direction (A1=B), and a longitudinal size W1 of the control circuit is set to be the same as a size of a pixel array in the same direction. In a configuration shown in FIG. 4A, however, there is a problem that circuits and wires need to be placed as localized at four corners of a frame (particularly at two corners near external terminals) resulting in an increase of a frame size.

FIG. 4B is a diagram showing a wiring pitch in an element side substrate of a liquid crystal panel disclosed in Patent reference 2 (Japanese Patent Application Laid-Open Publication No. 2002-6331). In this case, a control circuit is divided into multiple parts to be placed in a frame. Also, an output position pitch A2 of the control circuit is set to be smaller than an arrangement pitch B of display elements in the same direction (A2<B). A total of each longitudinal size W2 of the control circuit is set to be sufficiently smaller than a size of a pixel array in the same direction. The control circuit and pixel interconnections are connected with fan-like diagonal wires.

This patent reference does not disclose specifically what extent a longitudinal size of the control circuit is reduced to. Actually, a control circuit needs to be shrunk to a certain extent (at least more than several percent) for obtaining such an area as a common transfer electrode can be placed therein. However, for reducing a longitudinal size of the control circuit to such an extent, it is necessary to change considerably a structure of a transistor or a wiring layout included in the control circuit. Also, a reduction of a longitudinal size thereof sometimes increases a lateral size thereof. Further, in a configuration shown in FIG. 4B, a wiring length and a wiring delay become irregular among diagonal wires connecting the control circuit and pixel interconnections, sometimes resulting in deterioration of a display quality.

FIG. 4C is a diagram showing a wiring pitch in the element side substrate 10, 20, or 30. In the element side substrate 10, 20, or 30, an output position pitch A3 of the control circuit is set to be smaller than an arrangement pitch B of the display elements in the same direction (A3<B), and a longitudinal size of the control circuit W3 is set to be smaller than a size of a pixel array in the same direction. The element side substrates 10, 20, and 30 are the same as the configuration shown in FIG. 4B in this point. Further in the element side substrates 10, 20, and 30, differently from the configuration shown in FIG. 4B, a difference between an output position pitch A3 of the control circuit and an arrangement pitch B of the display elements (B−A3) is set to be equal to or smaller than a minimum wiring width or a minimum wiring pitch allowed in designing the control circuit.

For exposing a circuit pattern on an element side substrate, an exposure apparatus having a resolution of, for example, around four micrometers is used. Also, for preventing a film residue or a broken line from being caused by a foreign particle in production, a layout is sometimes carried out using a design rule rougher than this resolution. In this manner, an element side substrate is laid out using a design rule of about several micrometers, and about ten micrometers in some locations.

However, all the circuits are not always laid out using a design rule to the limit, there are frequently scattered rooms of about several micrometers in a resulting layout. Therefore, for reducing a size of a flip-flop circuit or a sampling circuit included in a control circuit by a length less than a limit value of a design rule in a particular direction, it is not necessary to move transistors or wires included in these circuits significantly, but it is sufficient to save the rooms slightly. Thereby, without changing significantly layouts of a flip-flop circuit and a sampling circuit, sizes of these circuits can be reduced in a particular direction.

In this manner, a size of a flip-flop circuit or a sampling circuit can be reduced by a length equal to or less than a limit value of a design rule in a particular direction by utilizing scattered rooms in a resulting layout, and thereby a longitudinal size W3 of a control circuit can be reduced by a length equal to or less than n times, 3m times, or m times a limit value of a design rule, while a lateral length of the control circuit is kept almost the same (the same in the best case).

For example, in a liquid crystal panel having a dot configuration of 240 (columns)×RGB×320 (rows), a case in which rows of display elements are arranged in a pitch of 150 μm is considered. In this case, when an arrangement pitch of flip-flop circuits and the like included in a row control circuit is set to be smaller than an arrangement pitch of rows of display elements by 2 μm, a size of the row control circuit in the column direction becomes smaller than that of a pixel array in the column direction by 2 μm×320=640 μm.

The value of 2 μm is sufficiently small from the standpoint of a resolution of an exposure apparatus, and is a too small size even for a single wiring to be placed therein. Therefore, even if a size of a flip-flop circuit or the like included in a row control circuit in the column direction is reduced by 2 μm, a size of a flip-flop circuit or the like in the row direction changes very little. Thereby, while a size of a row control circuit in the row direction is kept the same, a size thereof in the column direction can be reduced by 640 μm.

Also, in a liquid crystal panel having a dot configuration of 240 (columns)×RGB×320 (rows), a case in which columns of display elements are arranged in a pitch of 50 μm is considered. In this case, when an arrangement pitch of sampling circuits and the like included in a column control circuit is set to be smaller than that of columns of display elements by 1 μm, a size of the column control circuit in the row direction becomes smaller by 1 μm×(240×3)=720 μm.

The value of 1 μm is sufficiently small from the standpoint of a resolution of an exposure apparatus, and is a too small size even for a single wiring to be placed therein. Therefore, even if a size of a flip-flop circuit or the like included in a column control circuit in the row direction is reduced by 1 μm, a size of a flip-flop circuit or the like in the column direction changes very little. Thereby, while a size of a column control circuit in the column direction is kept the same, a size thereof in the row direction can be reduced by 720 μm.

In this manner, in the above described example, it is possible to reduce a size of a row control circuit in the column direction by 640 μm, and to reduce a size of a column control circuit in the row direction by 720 μm. In a recent liquid crystal panel, a frame width is about 2 mm and a line width of a video signal line is around 50 μm. Therefore, when a longitudinal size of a control circuit is reduced by as large as 640 μm or 720 μm, it is possible to form a vacant area large enough to place a circuit such as a level shifter and multiple video signal lines. Note that, generally, in a color liquid crystal panel, a number of columns of display elements is larger than a number of rows of display elements. Therefore, even when an arrangement pitch of a sampling circuit and the like included in a column control circuit is reduced very slightly, a size of the column control circuit in the row direction can be reduced significantly.

Also, on the element side substrate 10, 20, or 30, the control circuit has a configuration of arranging flip-flop circuits and sampling circuits consecutively in a one-dimensional manner. Therefore, it is possible to prevent a boundary from appearing on a display screen, which is caused by a considerable local difference in lengths of wires connecting a control circuit and pixel interconnections when the control circuit is divided into multiple parts to be placed in a frame.

Hereinbelow, a wire connecting a control circuit and a pixel interconnection (hereinbelow, called connection wire) in the element side substrate 10, 20, or 30 will be described. In the element side substrate 10, 20, or 30, a diagonal wire connecting an output position of a control circuit and a pixel interconnection in a straight manner may be used for a connection wire. In this case, while lengths of connection wires become irregular, the above mentioned straight diagonal wires can be used in a case a sufficient display quality can be obtained in spite of irregular lengths of connection wires.

In a case a sufficient display quality can not be obtained with straight diagonal wires, lengths of connection wires can be uniformized by use of a wire with a bending at a relay point thereof as a connection wire. In FIG. 4C, output positions of a control circuit or pixel interconnections are referred to as the first one, the second one, . . . and the z-th one in order from the left. The first output position and the first pixel interconnection are connected with a straight diagonal wire L1, and the z-th output position and the z-th pixel interconnection are connected with a straight diagonal wire L2. Angles formed by diagonal wires L1 and L2 against a longitudinal side of the control circuit are denoted by θ1 and θ2, respectively. Here, as shown in FIG. 4C, when the control circuit and the pixel array are arranged in center alignment, θ1 is equal to θ2.

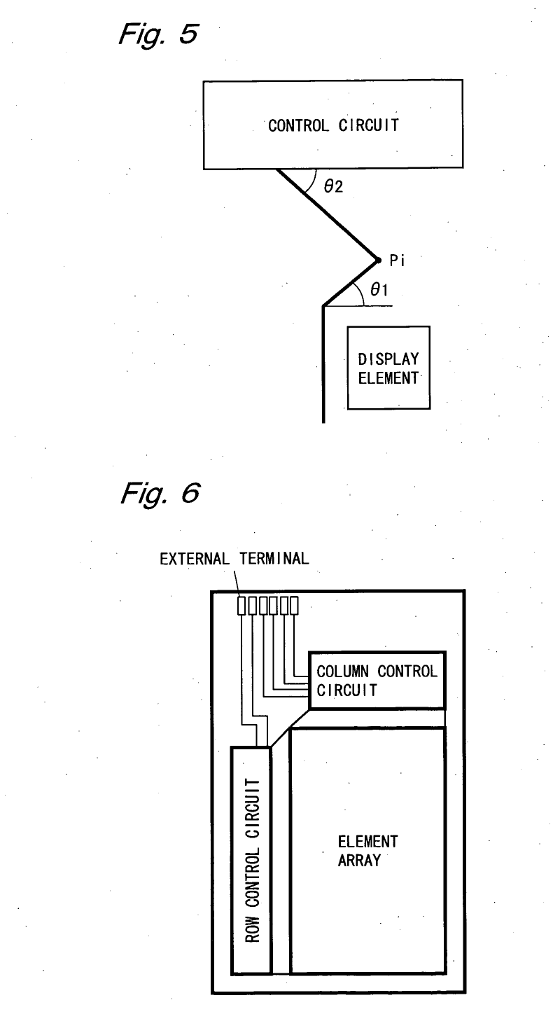

With reference to FIG. 5, a shape of a connection wire at an arbitrary position will be described. FIG. 5 is an enlarged diagram of a part X in FIG. 4C. An intersection of a straight line passing through the i-th (i is an integer satisfying 1<i<z) output position and parallel to the diagonal wire L2 and a straight line passing through an end of the i-th pixel interconnection and parallel to the diagonal wire L1 is denoted by Pi. The i-th output position and the i-th pixel interconnection are connected with a wire connecting the i-th output position and the point P1 and a wire connecting the point Pi and the end of the i-th pixel interconnection (that is, with a wire connecting the i-th output position and the end of the i-th pixel interconnection and having a bending at point P1).

When the connection wires shown in FIG. 4C and FIG. 5 are used, lengths of connection wires become uniform and wiring resistances and capacitances of the connection wires become uniform. Therefore, it is possible to prevent a display unevenness caused by fan-like diagonal wires.

Alternatively, on the element side substrate 10, 20, or 30, connection wires shown in FIG. 4D may be used. In an element side substrate of a liquid crystal panel, wires and circuits are frequently localized by an end of a control circuit. In this case, the control circuit may be placed apart from the area where wires and circuits are localized. Specifically, the control circuit may not be placed in center alignment with a pixel array, and an angle of a connection wire may be made larger in the neighborhood of one end of the control circuit (left end in FIG. 4D) and may be made smaller in the neighborhood of the other end of the control circuit (right end in FIG. 4D). Thereby, a sufficiently large vacant area can be formed by an end of the control circuit (left end in FIG. 4D).

In a case the connection wires shown in FIG. 4D are used, a reduced amount (B−A4) in an arrangement pitch of a flip-flop circuit and a sampling circuit included in a control circuit is smaller than the reduced amount (B−A3) in the case shown in FIG. 4C. Therefore, it becomes less necessary to modify layouts of transistors or wires constituting a flip-flop circuit and sampling circuit included in a control circuit. Thereby, a longitudinal size of a control circuit can be reduced almost without changing a lateral length of the control circuit, and a frame size of an element side substrate can be reduced.

Note that, in a case a diagonal wire shown in FIGS. 4C and 4D is used for a connection wire, a layout is desirable to make a length of the connection wire (in other words, separation size of the control circuit and the element array) as short as possible. That is, it is desired to layout so as to make the separation size of a control circuit and an element array sufficiently small compared to a lateral size of the control circuit. For example, in a case a lateral size of a control circuit is several millimeters, the separation size is assumed to be about the same as that of a conventional liquid crystal panel (that is, several hundreds of millimeters), and the layout is desired to be adjusted such that diagonal wires are placed within a area with this separation size. In such a layout, the separation size does not increase even if a diagonal wire is used for a connection wire and a frame size of an element side substrate can be prevented from increasing.

While an element side substrate of a liquid crystal panel has been described as an example of a device substrate according to the present invention, hereinabove, the present invention can be applied to another device substrate on which an element array and a control circuit thereof are formed monolithically. For example, the present invention can be applied to a display panel such as an organic electro-luminescence panel and a sensor panel such as a sensor matrix. Also in an application to another device substrate, a size of a device substrate can be reduced, when a longitudinal size of a row control circuit or a column control circuit is made smaller than a size of an element array in the same direction to form a vacant area and circuits or wires are placed in the vacant area formed thereby.

Many variations can be devised for an application configuration of a vacant area formed by a reduction in a longitudinal size of a row control circuit or a column control circuit. FIGS. 6 to 15 are plan views of device substrates according to embodiments of the present invention. With reference to FIGS. 6 to 15, various kinds of embodiments of the present invention will be described, including the above described configurations. Here, in FIGS. 6 to 15, a solid line shows a video signal line with an emphasis, and LS indicates a level shifter. Also, in the following description, while a level shifter is placed as a typical example of a circuit interposing between external terminals and a control circuit, another circuit (for example, power supply circuit) may be similarly placed on a device substrate.

Case 1: Wires are localized in a corner of a device substrate (FIG. 6).

When a certain circuit is formed monolithically on a device substrate, control wires of the circuit are sometimes localized in a corner of a device substrate, resulting in an increase a size of the device substrate. Then, the wires are placed in a vacant area formed by application of the present invention, and thereby the size of the device substrate can be reduced. Also, it is possible to connect the circuit formed on the device substrate and an external terminal with a short wiring to operate the circuit stably.

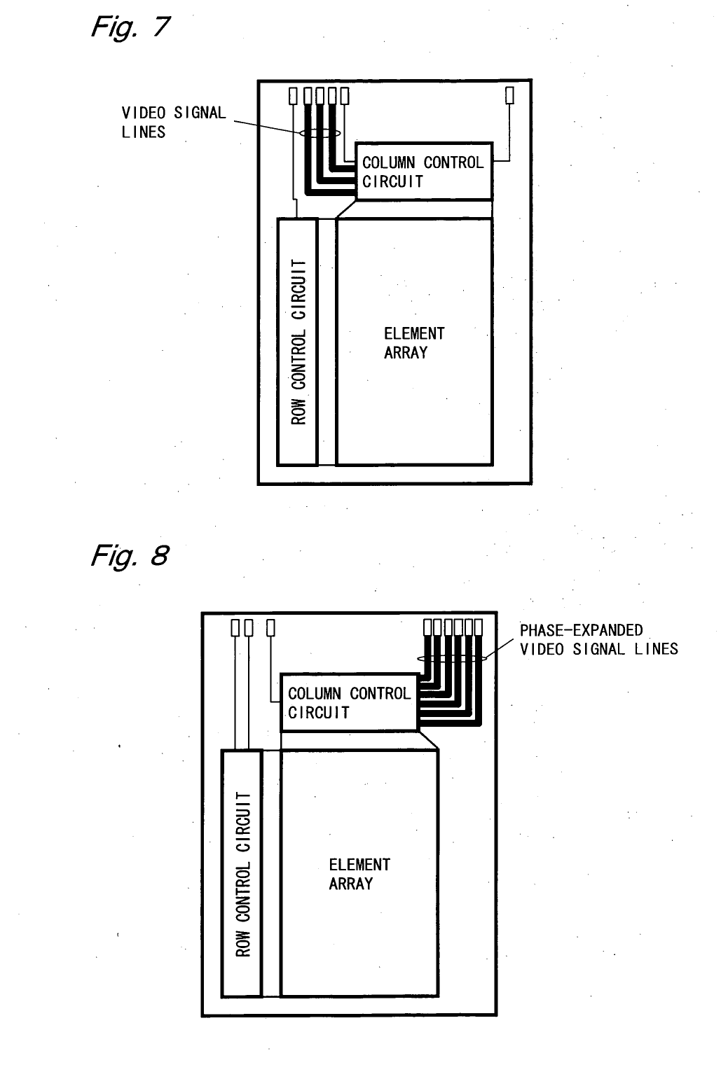

Case 2: A group of wires for transmitting multiple signals of the same kind simultaneously is localized in a corner of a device substrate (FIG. 7).

For preventing wires from localizing in a corner of a device substrate, there is devised a method in which the wires are divided into two or more groups and wires included in each of the group are placed in a different path. However, when this method is applied to a wire group for transmitting multiple signals of the same kind simultaneously (for example, video signal wiring group for transmitting multiple analog video signals corresponding to respective color components), wiring lengths and wiring delays become irregular, sometimes resulting in deterioration of a display quality. Therefore, the wire group for transmitting multiple signals of the same kind simultaneously needs to be placed in the same path. Then, the wire group for transmitting multiple signals of the same kind simultaneously is placed in a vacant area formed by application of the present invention, and thereby it is possible to reduce a size of a device substrate while keeping equality of lengths thereof by placing the wire group in the same path.

Also, on a device substrate provided with elements accommodating four or more colors, four or more video signal lines corresponding to respective color signals, are placed in a vacant area formed by application of the present invention, and thereby it is possible to reduce a size of the device substrate while keeping equality of lengths thereof by placing the four or more video signal wires in the same path.

Case 3: Phase-expanded video signal lines are localized in a corner of a device substrate (FIG. 8).

Video signals supplied to a device substrate are sometimes provided with a phase expansion. Generally, when a phase expansion number is denoted by “a”, 3a video signal lines are placed on the device substrate. Then, the phase-expanded video signal lines are placed in a vacant area formed by application of the present invention, and thereby it is possible to reduce a size of the device substrate while keeping equality of lengths thereof by placing the wire group in the same paths.

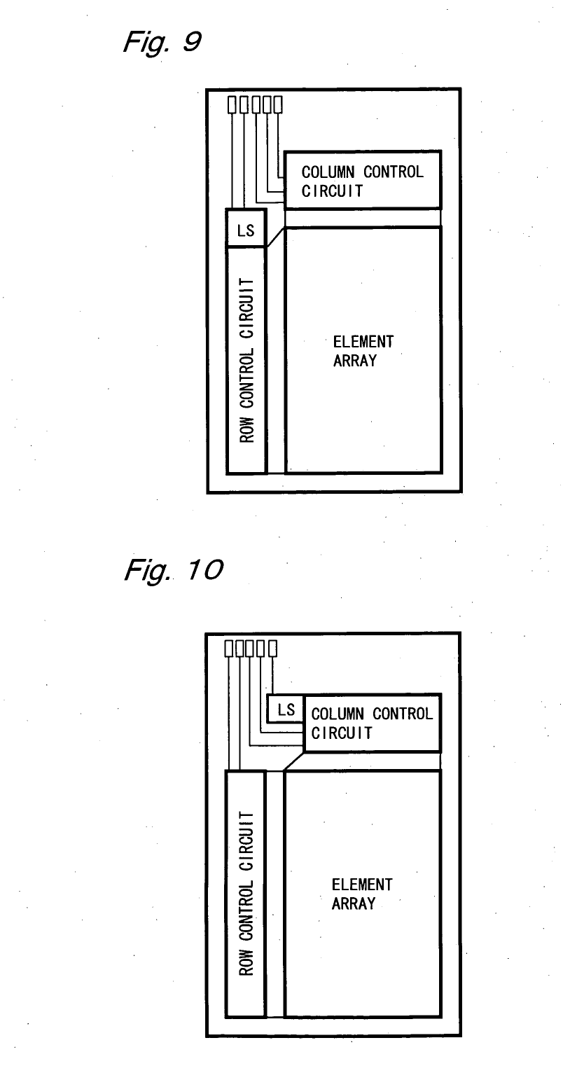

Case 4: A row-side level shifter is formed monolithically (FIG. 9).

In a case a row control circuit can not be controlled directly with a signal input via an external terminal, a level shifter is arranged between the external terminal and the row control circuit for converting a level of the signal transmitted therebetween. This level shifter is preferably placed in a corner of a device substrate where a column control circuit and wires also placed and a size of the device substrate sometimes increases. Then the row-side level shifter is placed in a vacant area formed by application of the present invention, and thereby the size of the device substrate can be reduced.

Case 5: A column-side level shifter is formed monolithically (FIG. 10).

In a case a column control circuit can not be controlled directly with a signal input via an external terminal, a level shifter is arranged between the external terminal and the column control circuit for converting a level of the signal transmitted therebetween. This level shifter is preferably placed in a corner of a device substrate where a row control circuit and wires also placed and a size of the device substrate sometimes increases. Then the column-side level shifter is placed in a vacant area formed by application of the present invention, and thereby the size of the device substrate can be reduced.

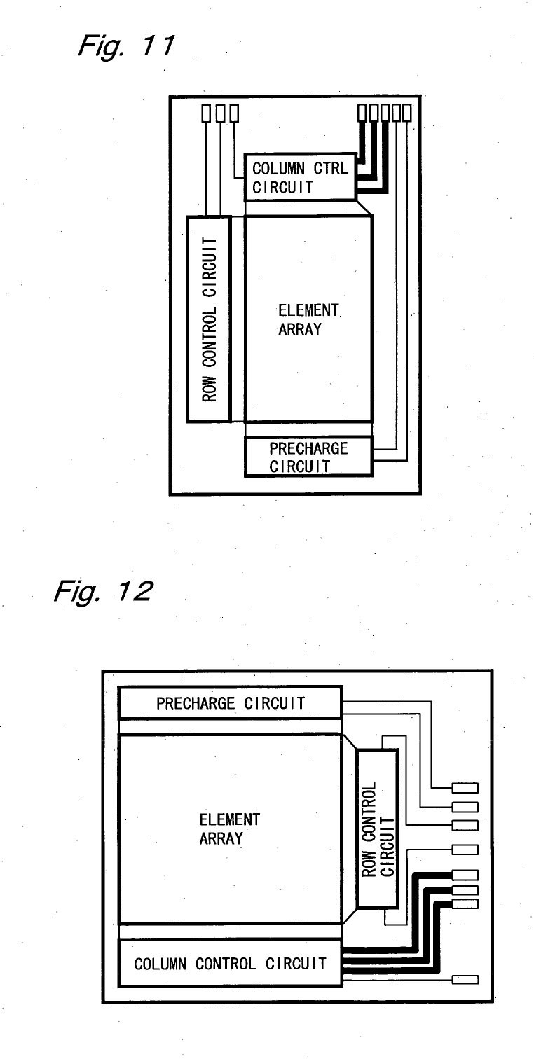

Case 6: A precharge circuit is formed monolithically (FIG. 11).

A precharge circuit is sometimes placed along a side of an element array on a device substrate in the row direction for precharging a column wire corresponding to a column of elements. For example, on an element side substrate of a liquid crystal panel, a precharge circuit which precharges column wires is placed for improving a charging rate of a display element. However, on a device substrate provided with a precharge circuit, wires are localized in a corner of the device substrate because wires for the precharge circuit are placed there, and a size of the device substrate sometimes increases. Then, the wires connecting external terminals and the precharge circuit are placed in a vacant area formed by application of the present invention, and thereby the size of the device substrate can be reduced.

Case 7: External terminals are provided along a longitudinal direction of a row control circuit (FIG. 12).

On the above described device substrates (refer to FIGS. 1 to 3 and FIGS. 6 to 11), external terminals are provided along a longitudinal direction of a column control circuit on the opposite side of the column control circuit from an element array. On such a device substrate, wires are localized by an end or both ends of the column control circuit. On the other hand, in a device substrate shown in FIG. 12, external wires are provided along a longitudinal direction of a row control circuit on the opposite side of the row control circuit from an element array. In such a device substrate, wires are localized by an end or both ends of the row control circuit and a size of the device substrate increases. Then, the wires are placed in a vacant area formed by application of the present invention, and thereby the size of the device substrate can be reduced.

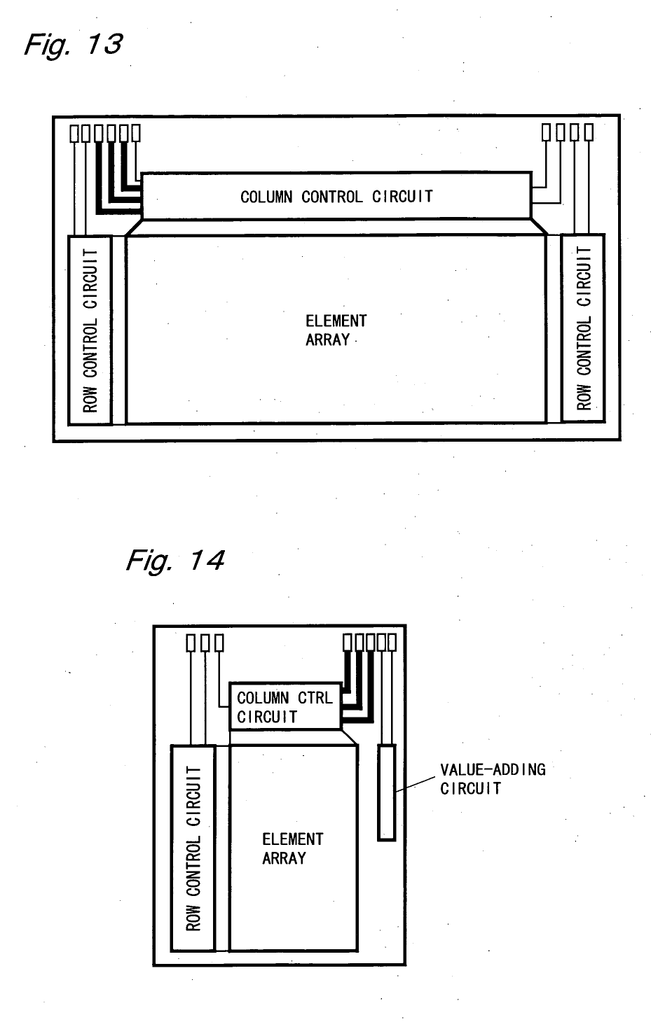

Case 8: A row control circuit is divided to be placed on both sides of an element array (FIG. 13).

A row control circuit is sometimes divided to be placed in both sides of an element array on a device substrate. For, example, since a resistance of a scanning signal line becomes higher in a large screen liquid crystal panel, there is sometimes employed a method in which an element array is divided into two, left and right, and each scanning signal line is driven from both left and right sides of the element array. On such a device substrate, wires are localized by an end or both ends of the row control circuit and a size of the device substrate increases. Then, the wires are placed in a vacant area formed by application of the present invention, and thereby the size of the device substrate can be reduced.

Case 9: A circuit unrelated to a control of elements is formed monolithically (FIG. 14).

A circuit unrelated to a control of elements (hereinafter, called value-adding circuit) is sometimes provided on a device substrate. For example, on an element side substrate of a liquid crystal panel, an audio-amplifier circuit, an illuminance sensor circuit or the like is sometimes provided as a value-adding circuit. A size of a device substrate including a value-adding circuit is preferably smaller, considering integration thereof into a device. Then, wires for a value-adding circuit are placed in a vacant area formed by application of the present invention, and thereby the size of the device substrate can be reduced.

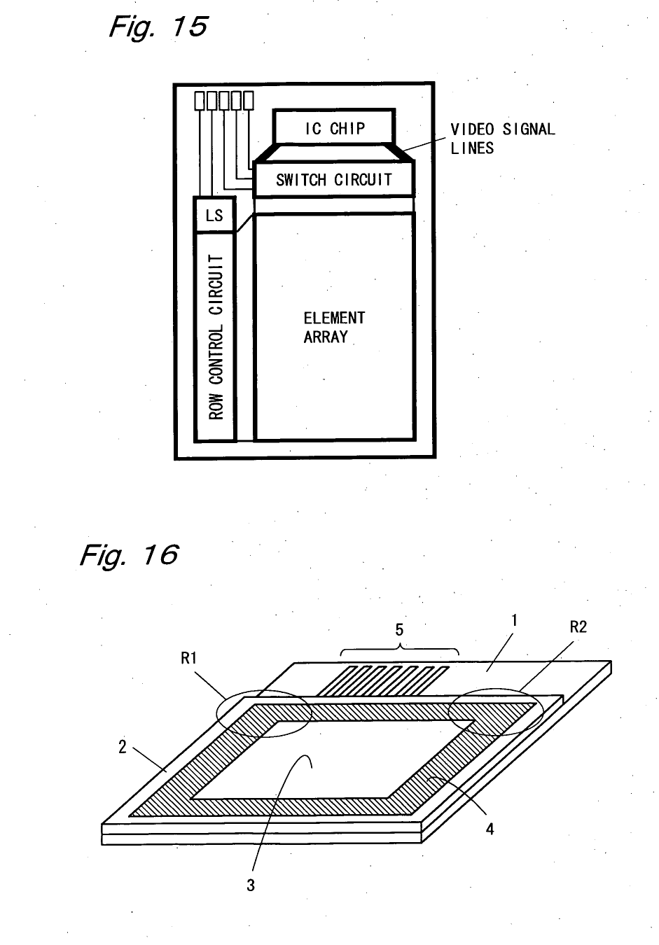

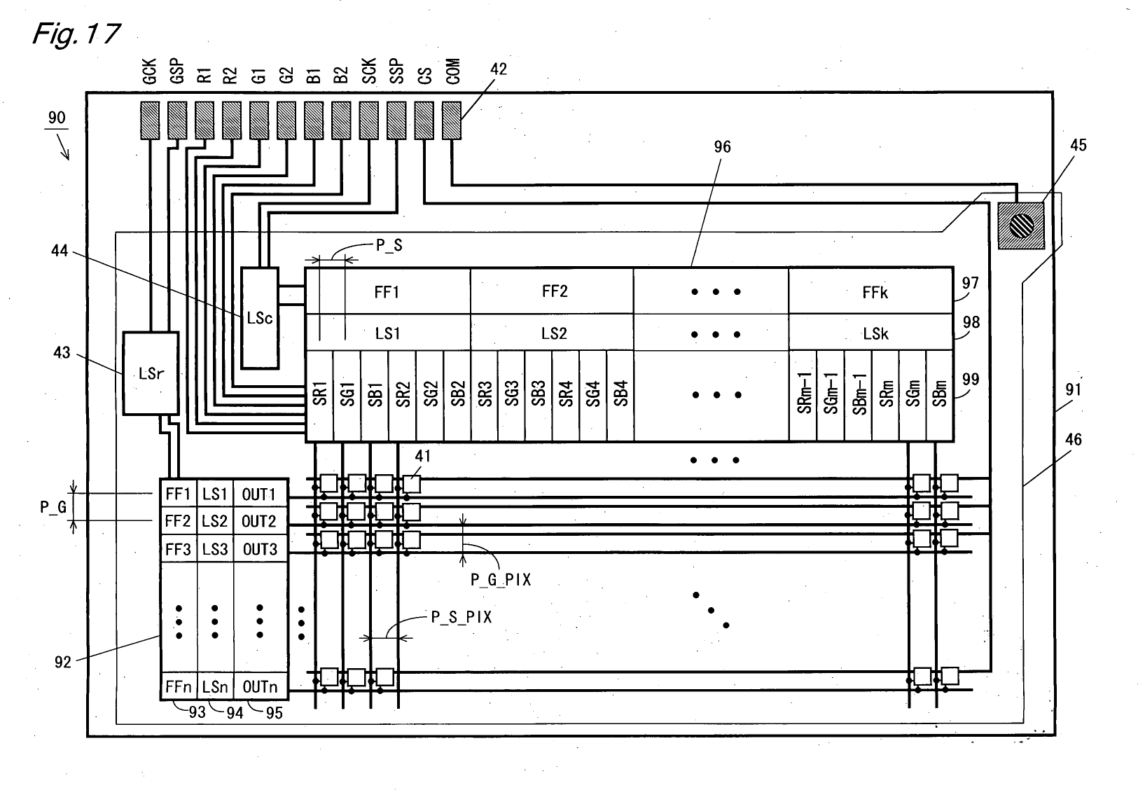

Case 10: A column control circuit is constituted of a switch circuit formed monolithically and an IC chip (FIG. 15).

A column control circuit provided on a device substrate is sometimes constituted of a switch circuit formed monolithically on a base substrate and an IC chip mounted on the base substrate. In this case, video signal lines connected to the column control circuit are placed between the switch circuit and the IC chip, and wires are seldom localized in a corner of the substrate because of the video signal lines. In a case a row-side level shifter is placed in a corner of the device substrate, however, a switch circuit and control wires for the switch circuit are also placed there, sometimes to increase a size of the device substrate. Then, the row-side level shifter is placed in a vacant area formed by application of the present invention, and thereby the size of the device substrate can be reduced.

Note that, when a device substrate as shown in FIGS. 6 to 15 is used for an element side substrate of a liquid crystal panel, this element side substrate may be bonded with an opposite substrate as shown in FIG. 16. Thereby, a liquid crystal panel having a small overall size can be obtained.

As described hereinabove, by use of a control circuit having a longitudinal size smaller than a size of an element array in the same direction, a vacant area is formed in a frame, on a part of which the control circuit is placed, according to the device substrate of the present invention. Therefore, a frame size of a device substrate can be reduced when a circuit or a wire are placed in the formed vacant area. Also, by the reduction of the frame size, the number of device substrates mountable on a mother substrate is increased to reduce a cost of the device substrate. Also, a longitudinal size of a control circuit can be reduced almost without increasing a lateral size of the control circuit, since a difference between an arrangement pitch of rows or columns of elements and that of unit control circuits included in the control circuit is small.

Also, according to the liquid crystal panel of the present invention which is provided with such a device substrate as an element side substrate, an overall size of a liquid crystal panel can be reduced and also a cost of a liquid crystal panel can be reduced, by a reduction in a frame size of an element side substrate.

### INDUSTRIAL APPLICABILITY

The device substrate according to the present invention has an advantage that a circuit and a wire can be placed in a vacant area generated by a difference in sizes between an element array and a control circuit, and a frame size of the device substrate can be reduced. Accordingly, the present invention can be applied to a variety of device substrates, on which an element array and a control circuit thereof are formed monolithically, for such as a liquid crystal panel, an organic electro-luminescence panel and a sensor matrix.

1. A device substrate having elements and a control circuit thereof formed monolithically; comprising:
a base substrate;
an element array including elements arranged in a matrix on the base substrate; and
a control circuit being placed along a side of the element array on the base substrate for controlling the elements by a row or by a column,
the control circuit having a configuration of arranging unit control circuits corresponding to control units of the elements consecutively in a one-dimensional manner, and
an arrangement pitch of the unit control circuits being smaller than that of the control units of the elements, and a difference between both of the pitches being equal to or smaller than a minimum wiring width or a minimum wiring pitch allowable in the control circuit.

2. The device substrate according to claim 1, wherein:
the control circuit has a configuration of arranging flip-flop circuits corresponding to rows of the elements consecutively in a one-dimensional manner along a side of the element array in a column direction thereof; and
an arrangement pitch of the flip-flop circuits is smaller than that of the rows of the elements, and a difference between both of the pitches is equal to or smaller than the minimum wiring width or the minimum wiring pitch.

3. The device substrate according to claim 1, wherein:
the control circuit has a configuration of arranging flip-flop circuits corresponding to columns of the elements consecutively in a one-dimensional manner along a side of the element array in a row direction thereof; and
an arrangement pitch of the flip-flop circuits is smaller than that of the columns of the elements, and a difference between both of the pitches is equal to or smaller than the minimum wiring width or the minimum wiring pitch.

4. The device substrate according to claim 1, wherein:
the control circuit has a configuration of arranging sampling circuits corresponding to the columns of the elements consecutively in a one-dimensional manner along a side of the element array in a row direction thereof; and
an arrangement pitch of the sampling circuits is smaller than that of the columns of the elements, and a difference between both of the pitches is equal to or smaller than the minimum wiring width or the minimum wiring pitch.

5. The device substrate according to claim 1, wherein:
the control circuit is placed so as to form a vacant area near a corner of an outer peripheral part of the element array; and
a wiring group for transmitting multiple signals of the same kind simultaneously is placed in the vacant area.

6. The device substrate according to claim 5, wherein
the wiring group includes multiple video signal lines.

7. The device substrate according to claim 5, wherein
the wiring group includes multiple phase-expanded video signal lines.

8. The device substrate according to claim 5, wherein
the wiring group includes four or more video signal lines corresponding to respective color signals.

9. The device substrate according to claim 1, wherein:
the control circuit is placed so as to form a vacant area near a corner of an outer peripheral part of the element array; and
a level shifter converting a level of a signal transmitted between an external terminal and the control circuit is placed in the vacant area.

10. The device substrate according to claim 1, further comprising
a precharge circuit for precharging a column wire corresponding to a column of the elements placed along a side of the element array on the base substrate in a row direction thereof,
the control circuit being placed so as to form a vacant area near a corner of an outer peripheral part of the element array, and
a wire connecting an external terminal and the precharge circuit passing through the vacant area.

11. The device substrate according to claim 1, further comprising
another control circuit being placed along another side of the element array on the base substrate, for controlling the elements either by a row or by a column differently from the control unit.

12. The device substrate according to claim 11, wherein:
the control circuit is placed so as to form a vacant area near a corner of an outer peripheral part of the element array; and
a level shifter converting a level of a signal transmitted between an external terminal and the another control circuit is placed in the vacant area.

13. The device substrate according to claim 1, further comprising
another control circuit being divided into a first part and a second part to be placed along other two sides of the element array on the base substrate, for controlling the elements either by a row or by a column differently from the control circuit,
the control circuit being placed so as to form vacant areas near two corners of an outer peripheral part of the element array, respectively, and
a wire connecting an external terminal and the first part passing through one of the vacant areas and a wire connecting an external terminal and the second part passing through the other of the vacant areas.

14. A liquid crystal panel having a structure of bonding two substrates, comprising:
an element side substrate including a base substrate, a pixel array having display elements arranged in a matrix on the base substrate, and a control circuit being placed along a side of the pixel array on the base substrate for controlling the display elements by a row or by a column; and
an opposite substrate facing the element side substrate;
the control circuit having a configuration of arranging unit control circuits corresponding to control units of the display elements consecutively in a one-dimensional manner, and
an arrangement pitch of the unit control circuits being smaller than that of the control units of the display elements and a difference between both of the pitches being equal to or smaller than a minimum wiring width or a minimum wiring pitch allowable in the control circuit.
